(19) United States
(12) Patent Application Publication
(10) Pub. No.: US 2011/0068056 A1
(43) Pub. Date: Mar. 24, 2011

(54) Method for the Biological Treatment of an Effluent and Associated Plant

(76) Inventors: Marc Caligaris, Jouy Le Moutier (FR); Chrystelle Ayache, Cormeilles-En-Parisis (FR); Emmanuel Trouve, Barberaz (FR)

(21) Appl. No.: 12/993,345

(22) PCT Filed: May 25, 2009
(86) PCT No.: PCT/FR09/00600

§ 371 Date: Nov. 18, 2010

(30) Foreign Application Priority Data
May 26, 2008 (FR) 0853416

(51) Int. Cl. C02F 3/12

(52) U.S. Cl. 210/614; 210/624; 210/195.3

(57) ABSTRACT

The invention relates to a method for the biological treatment of an effluent to be treated and containing at least two forms of pollution, one of which is more easily biodegradable than the other, which comprises using a main biological treatment area in which the raw effluent is contacted with biological sludge adapted for consuming a first form of pollution that can be more easily degraded than a second form of pollution, wherein said method is characterised in that comprises collecting a fraction at least of the biological sludge which is isolated at a distance from the main biological treatment area in a so-called bioactivation area and under aeration and time conditions adapted for triggering in said fraction the development of new biological functions capable of consuming the second form of pollution, and further recycling at least a portion of said biological sludge fraction towards the main biological treatment area.

This application is a U.S. National Stage Application of PCT Application No. PCT/FR2009/000600, with an international filing date of 12 Feb. 2009. Applicant claims priority based on French Patent Application No. 0853416 filed 26 May 2008. The subject matter of these applications is incorporated herein.

The invention relates to a method and a device for the biological treatment of polluted effluents, in particular waste water, for example urban or industrial waste water, implementing control of a biomass within a biological reactor.

As is known, the principal of a biological treatment of pollution consists in supplying a raw effluent loaded with pollution to a population of bacteria (constituting a biomass) capable of feeding on this pollution to be treated.

It is understood that the proliferation of bacteria capable of consuming this pollution is thus promoted naturally such that, even though the pollution is partially converted by the bacteria into nitrogen and carbon dioxide, the biomass grows continuously, which makes it necessary to provide for the excess biomass to be removed.

It should be specified here that sludges form during a biological treatment, and that they comprise biomass, i.e. the various bacterial populations which have been able to proliferate by feeding on pollution contained in the raw effluent, and non-degraded particles of pollution.

The treatment and discharge of these sludges are becoming an important issue, from both the environmental and the economic point of view, which explains why it has already been suggested that an attempt be made to control biomass with a view to optimizing the process, for example by reducing the quantity of biological sludges formed.

Thus a method for the biological treatment of effluents is known, according to the document EP-1 486 465 (ONDEO), that comprises a stage of control of bacterial growth upstream of the activated sludge tank.

This document recommends the implementation of a control tank in which the optionally thickened sludges, obtained by clarification of the flow coming from a biological tank, accumulate.

The redox potential of this control tank is regulated by acting on an inlet flow into this reactor of this raw effluent to be treated or on an outlet flow of sludges from this reactor to the biological tank, so that this potential remains as close as possible to the equilibrium value between an oxidizing state and a reducing state: it follows from this that reactions using oxidizing and reducing compounds are thus implemented.

In this way, the development and bacterial growth in the control tank are apparently limited.

Moreover, a method for the treatment of waste water by fixed biological cultures is known, according to the document FR-2 844 786 (ONDEO), that involves a step of purification and a step of reduction of the production of sludges, these two stages being separated.

The step of reduction of the production of sludges includes a thermophilic enzymatic degradation step followed by a step of biological treatment by activated sludges.

The secondary reactor is therefore heated in order to select a thermophilic biomass and cause lysis resulting in the occurrence of a substrate that is nutritious for the bacteria of the biological treatment.

A method and apparatus for the biological treatment of waste water are also known, from the document U.S. Pat. No. 5,356,537 (Thurmond et al), that involves an aeration reactor and a clarifier carrying out a separation of the clusters of activated sludges from the rest of the liquid.

The method also involves sending a 5 to 25% fraction of the activated sludge into an aerobic “digestion” reactor for 16 to 24 h before reinjecting it upstream of the aeration reactor.

Nevertheless, the known methods are often limited in terms of efficiency of the degradation of the pollution, in particular when there are different chemical species present and that some are more difficult to degrade than others. Moreover, the known methods do not allow the treated organic matter to be valorized, which is disadvantageous on the economic level.

The subject of the invention is to overcome these drawbacks.

To this end, the aim is a method and a device for biological treatment implementing an active control on the biomass so as to lead to the consumption of as much as possible of the various types of pollution contained in the raw effluent and the production of the compounds of interest, without involving a large investment or demanding operating conditions.

The invention thus proposes a method for the biological treatment of an effluent to be treated containing at least two types of organic pollution, one of which is more easily biodegradable than the other, using a main zone for aerated biological treatment in which the raw effluent is brought into contact with biological sludges suitable for consuming a first type of pollution that is easier to degrade than a second type of pollution, the method being characterized in that at least a fraction of the biological sludges that are isolated at a distance from the main biological treatment zone is removed, under aeration and time conditions suitable for bringing about a development of new biological functions in this fraction able to consume the second type of pollution and then at least a part of this fraction of biological sludges is recycled to the main biological treatment zone.

It will be appreciated that the invention involves the synergy of several areas of expertise:
microbiology in order to monitor the cellular viability of the method and the bacterial fauna established in the biological treatment zone;
enzymology in order to promote certain advantageous biological reactions.

The invention thus comprises the combination:
of a metabolic control method for the sludges within an adjoining zone, in practice constituted by a reactor called a bioactivation reactor, implementing a recirculation loop between the biological treatment zone and the bioactivation zone; the residence time of the sludges in the bioactivation reactor being defined according to the type of the sludge of the biological treatment zone, such an adjustment being novel per se;
and of a method for controlling the metabolism of the biomass in order to degrade the particulate pollution by secretion of specific compounds (enzymes or others) and/or by adaptation of the biomass of the sludges; and by keeping the biomass in this bioactivated state (i.e. with biologically modified activity) for an appropriate time before its reinjection into the biological treatment zone, this aspect being novel per se.

In a family of embodiments, the bioactivation zone is aerated, the residence time of the isolated fraction of sludges being comprised between 1 and 21 days.

In another family of embodiments, the bioactivation zone is anaerobic, the residence time of the fraction of isolated sludges being defined according to the age of the biological sludges.

An optional thickening can also be implemented. If the sludges are not thick, it is useful to increase the substrate-biomass contact surface. In all cases, it can be useful to reduce the volume of the tank. A mixer can be used to ensure a homogeneity of the sludges if they are thick.

An additional, optional, conditioning stage can be added with a view to a subsequent valorization of removed compounds of interest in the flow coming from the bioactivation zone to the biological treatment zone, which allows the efficiency of the production of these compounds of interest (in particular: enzymes, biopolymers, etc.) to be increased while the object of the method is centred more specifically on this purpose.

It has been seen that the existing systems are based on cellular lysis and/or mechanical, thermal or chemical solubilization in a reactor that is adjoining or not.

By contrast, according to the invention, the degradation of the pollution or the production of compounds of interest takes place in a biological treatment reactor (unlike the aforementioned document U.S. Pat. No. 5,356,537 in particular), preferably at ambient temperature (no thermal treatment is necessary for the selection and/or conditioning of the biomass) and without involving a cellular lysis (unlike the document FR-2 844 786 in particular), by an endogenous fauna, capable of coexisting in the biological treatment reactor and of lasting there (unlike FR-2 844 786 in particular) and by a specific biomass in an adjoining reactor (unlike EP-1 486 465).

Thus, the bioactivation zone, owing to the fine control and command of the biological phenomena that occur there, allows the sludge contained in the biological treatment zone to be maintained in an optimum state, with a view to consuming, after recirculation into the biological treatment reactor, the majority of the pollution, including the pollution that is difficult to biodegrade, and converting the more significant organic matter.

The result is a more thorough purification, or a production of compounds of interest or a minimization of the sludges formed.

The act of diversifying the bacterial populations present in the biological treatment zone has the advantage, for a generally moderate increase in the biomass, of greatly reducing the part of the sludges constituted by pollution that is not consumed or degraded and/or producing compounds with added value.

It may be noted that, according to the invention, the bioactivation zone is placed downstream of the biological treatment zone and in no case receives the raw effluent, since it is desired to induce a nutritional deficiency in this bioactivation zone; the metabolic control of the isolated fraction is therefore based not on the redox potential but on other parameters that it had not been normal to monitor: soluble chemical oxygen demand (or COD), nitrates content, exopolysaccharides content, or enzymatic activities such as ATP (adenosine triphosphate).

Moreover, heating the bioactivation zone is not obligatory; there is therefore not necessarily a selection of bacteria according to the temperature.

In addition, it is not in the bioactivation zone that the conversion of the pollution takes place but in the biological treatment zone itself. The activation of the isolated fraction is controlled by monitoring measurements of biological activities of this isolated fraction (according to the case: soluble COD content, nitrates, saccharides, in particular exopolysaccharides contents, ATP value, etc.).

The residence time of the sludges in the bioactivation zone is adapted to the nature of the isolated fraction of sludges and can vary from 1 to 48 hours under anaerobic conditions and from 1 to 21 days under anoxic or aerobic conditions. Under anaerobic conditions, the residence time can be fixed as a function of the age of the sludges of the main biological treatment zone: the older the sludges are, the longer the residence time in the bioactivation zone is. A proportionality relationship between these two variables can be chosen. It should be recalled that the age of the sludges is defined by the relationship between the quantity of matter present in suspension in the aeration tank and that extracted per unit of time, that is to say the residence time of the biomass in the tank.

According to an optional and advantageous feature of the invention, the aeration and time conditions are suitable for converting the second type of pollution into valorizable products.

Other optional features can possibly be combined with the previous features.

According to an optional feature, the fraction of the biological sludges that is isolated is chosen between 30% and 600% of a daily production of sludges of the main treatment zone or preferably between 30 and 300%.

The fraction of sludges removed can be defined by a predetermined rate with respect to the production of sludges of the method in particular during the reference period.

According to an optional feature, the aeration and time conditions are defined as a function of the monitoring of at least one parameter preferably directly characterizing the biological state of the fraction of isolated sludges, and preferably the state of activity of the biomass.

The aeration and time conditions can be predefined or continuously defined.

According to an optional feature, this parameter is chosen from an indicator of suspended matter (or MES), a soluble or total chemical oxygen demand, an indicator of nitrogenous species, an enzymatic activity, a proteins indicator, a polysaccharides indicator or a composition of the biomass.

According to an optional feature, the aeration and time conditions are chosen so as to control at least one phenomenon chosen from a nutritional deficiency, a moderate inhibition, a pressure, a temperature, a pH, a change in the nature or in the concentration of electron acceptors.

According to an optional feature, the aeration and time conditions are such that a conversion of at least one type of pollution occurs in the isolated sludge fraction between the removal and the recycling.

The type of pollution which is thus converted can be the first type or the second type.

According to an optional feature, before the recycling, at least one subfraction that is isolated under aeration and time conditions sufficient for bringing about the development of other new metabolic functions capable of consuming another type of pollution is removed from the fraction, and at least a part of this subfraction is recycled into the biological treatment zone.

According to an optional feature, at least one second fraction of the sludges is removed and isolated from the biological treatment zone under aeration and time conditions sufficient for bringing about the development of other new metabolic functions capable of consuming other types of pollution, and at least a part of this second fraction is recycled into the biological treatment zone, the first and the second fractions of sludges being treated in parallel.

According to an optional feature, the development of new biological functions includes a proliferation of a biological species, a modification of a distribution of a production of intracellular enzymes, a modification of a distribution of emission of exocellular enzymes or a modification of a population dynamics of a species.

According to an optional feature, a concentration treatment is applied to the fraction before bringing about a development of new biological functions in the fraction.

According to an optional feature, the concentration treatment is applied until a concentration of at most 40 kg of sludge per m³ of liquid is obtained in the case where the majority of the sludges are formed of mesophilic populations.

According to another optional feature, the aeration conditions include an oxygen concentration of less than 2 mg of O2 per litre.

The invention also proposes, for the implementation of the method defined above, a plant for the biological treatment of an effluent to be treated containing at least two types of matter or organic pollution, one of which is more easily biodegradable than the other, the plant comprising a main zone for aerated biological treatment in which the raw effluent is brought into contact with biological sludges suitable for consuming the first type of pollution that is easier to degrade than the second, characterized in that it comprises a removal route for at least a fraction of the biological sludges connected to a secondary zone, the fraction being isolated at a distance from the main biological treatment zone, under aeration and time conditions sufficient for bringing about the development of new biological functions in this fraction capable of consuming the second type of pollution that is more difficult to degrade, and a line for recycling this fraction of biological sludges to the main biological treatment zone.

The plant can also comprise a valorization reactor system for products of interest, which can take the form in particular of a unit for conditioning products with a view to their valorization.

Objects, features and advantages of the invention will become apparent from the following description, given by way of illustrative, non-(imitative example, with reference to the attached drawings in which:

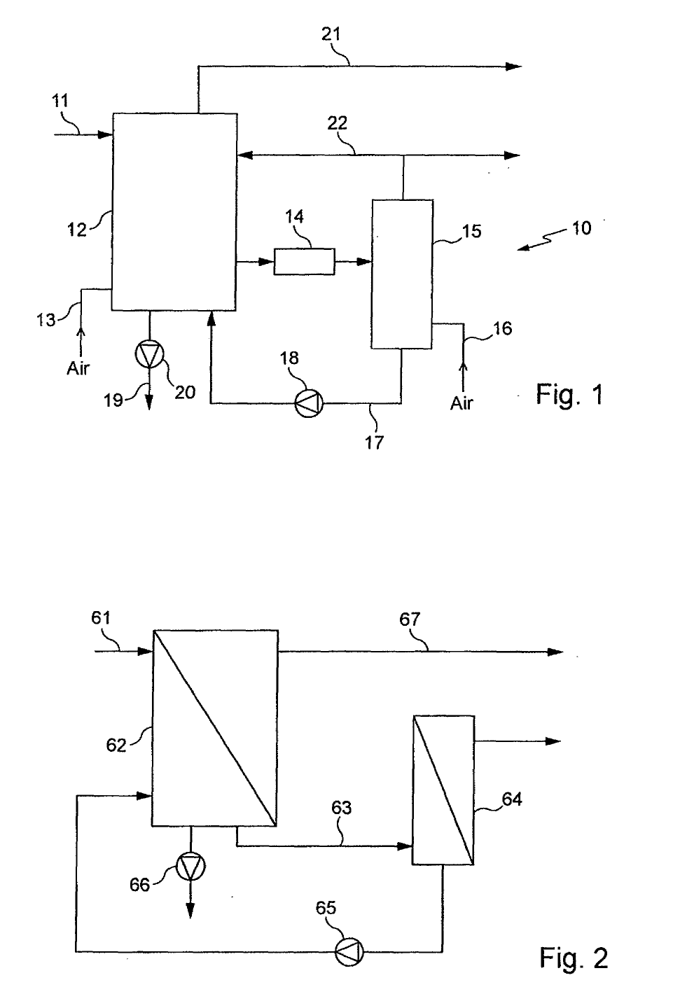

FIG. 1 is a block diagram of a biological treatment plant suitable for implementing the invention,

FIG. 2 is a diagram of this plant in a particular embodiment form,

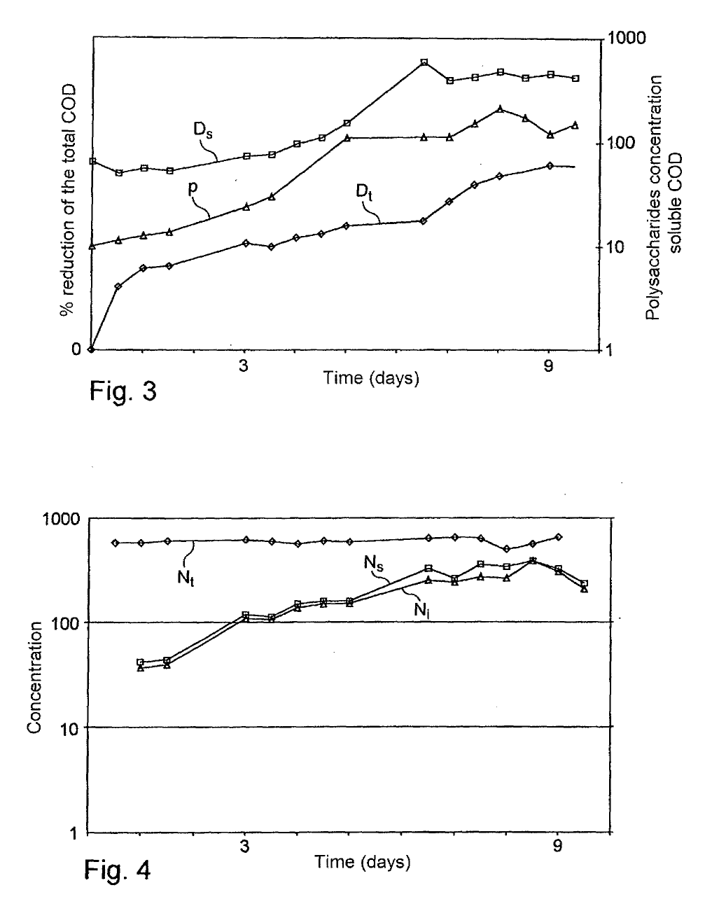

FIG. 3 is a graph showing the change over time of the total chemical oxygen demand (reduction of the COD), of the soluble COD and of the polysaccharides content, within the bioactivation reactor of FIG. 2,

FIG. 4 is a diagram showing the change over time of the nitrogenous forms within the bioactivation reactor of FIG. 2,

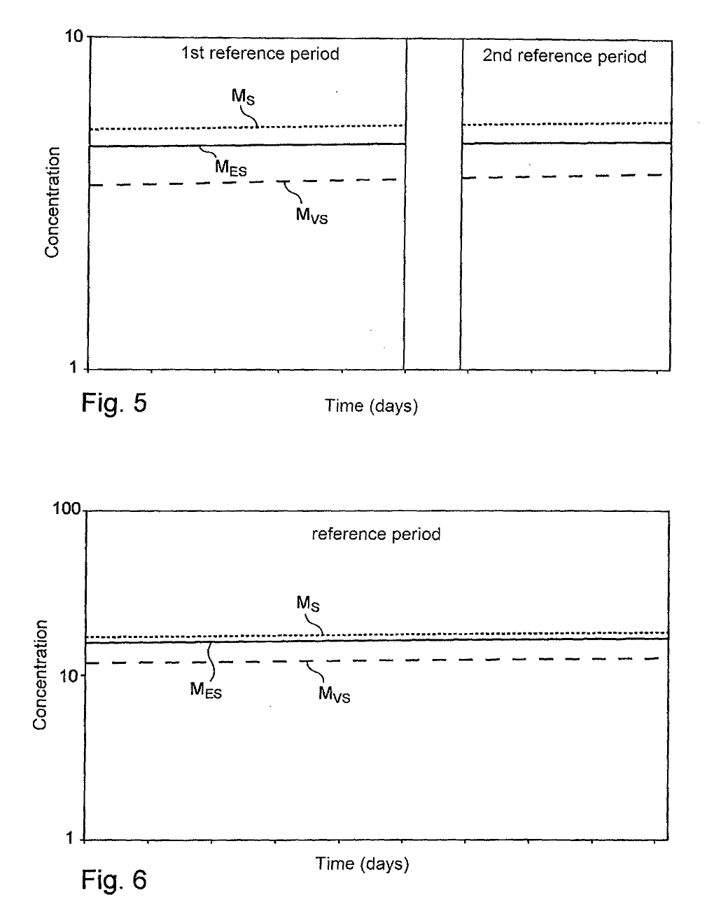

FIG. 5 is a graph showing the change over time of the content of sludges in the biological sludge tank of FIG. 2, during two reference periods,

FIG. 6 is a graph showing the change over time of the content of sludges (volatile suspended matter MVS, suspended matter MES and dry matter MS) within the bioactivation reactor of FIG. 2,

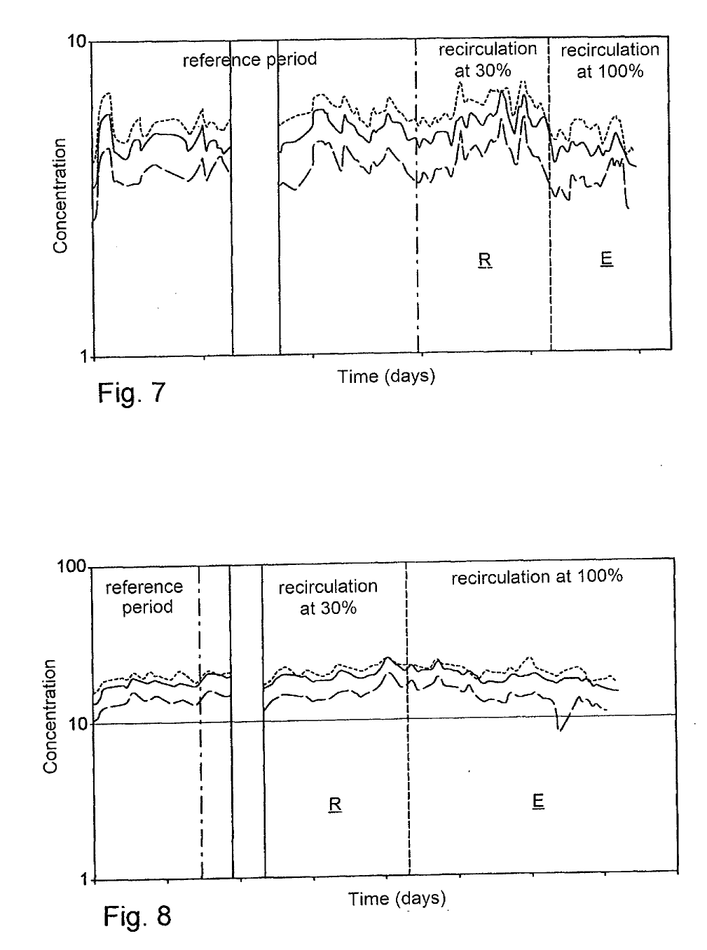

FIG. 7 is a graph showing the change over time of the content of sludges in the biological treatment reactor of FIG. 2, during two reference periods, a period of recirculation at 30% and a period of recirculation at 100%,

FIG. 8 is a graph analogous to that of FIG. 7, showing the change over time of the content of sludges in the bioactivation reactor of FIG. 2, during two reference periods, a period of recirculation at 30% and a period of recirculation at 100%,

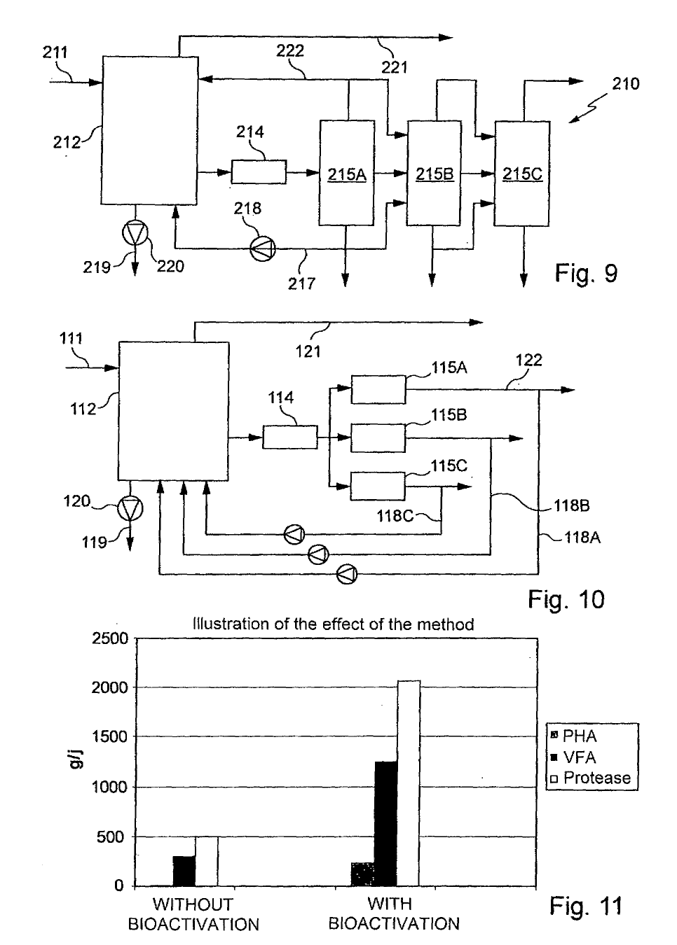

FIG. 9 is a block diagram of another plant conforming to the invention, comprising several bioactivation reactors in series,

FIG. 10 is a block diagram of yet another plant conforming to the invention, comprising several bioactivation reactors in parallel,

FIG. 11 is a graph of the results obtained with the device of FIG. 9,

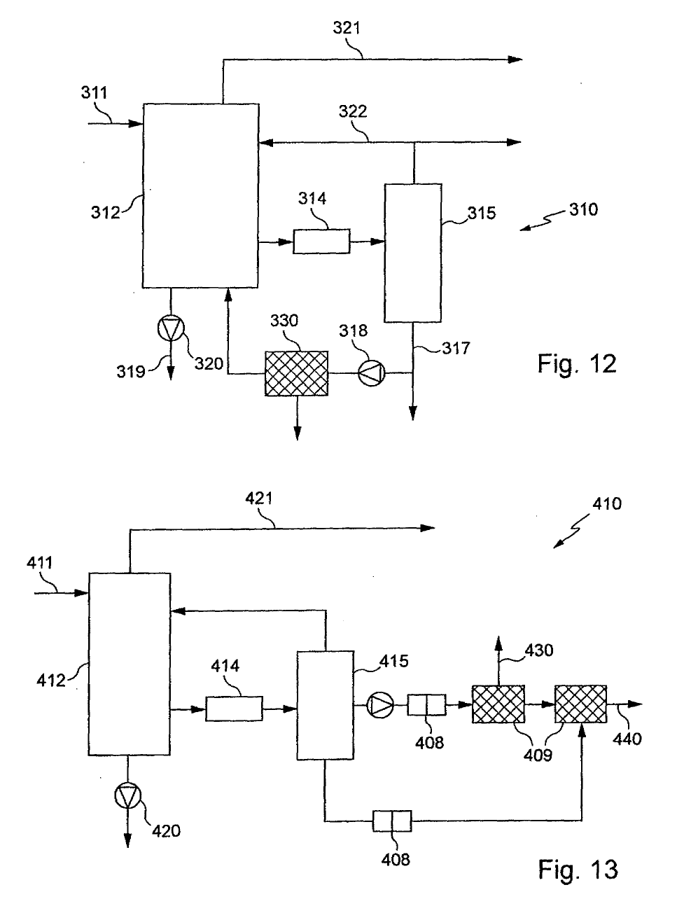

FIG. 12 is a block diagram of yet another plant conforming to the invention, comprising a conditioning zone between the bioactivation reactor and the biological treatment reactor, and

FIG. 13 is a diagram of another plant conforming to the invention, comprising a conditioning zone at the outlet from a bioactivation reactor.

### DETAILED DESCRIPTION

Two indicators are currently used for pollution. The first is a quantitative indicator indicating the distribution by mass of the main components carbon/nitrogen/phosphorus. It is used to measure the particulate organic matter (for example the bacteria), the mineral matter (for example the sands), the dissolved salts (containing nitrogen and phosphorus), the soluble organic matter (such as proteins or polysaccharides). The second is a qualitative indicator, concerning the assessment of levels of risk to health and the environment. It measures endocrine disruptors and heavy metals for example.

FIG. 1 represents a biological treatment plant 10 comprising:
an inlet route 11 for raw effluent, such as waste water,
a main biological treatment reactor 12, here provided with an air inlet 13 due to which the reactor 12 is an aerated reactor (continuous or sequenced aeration, in this case with the presence of temporal phases suitable for bringing about an aerobic treatment for carbon and ammonia, then an anoxic treatment for nitrates, then an anaerobic treatment for phosphorus),
a concentrator 14 connected, here in the lower part, to an outlet of the biological treatment reactor 12,
a bioactivation reactor 15, here aerated due to an air inlet 16, connected to the outlet of the concentration reactor,
a recirculation line for bioactivated sludges 17, connected between an outlet, here in the lower part, of the bioactivation reactor 15, and an inlet, here in the lower part, of the biological treatment reactor 12—the recirculation line 17 advantageously comprises a pump 18,
a discharge line 19 for excess sludges connected to an outlet of the biological treatment reactor and comprising a pump 20,
an outlet route for treated water 21, connected to an outlet, here in the upper part, of the biological treatment reactor, and
an outlet route 22, connected to an outlet of the bioactivation reactor, here in the upper part and able to reach, on the one hand, the biological treatment reactor and/or, on the other hand, an outlet of the plant.

Such a plant allows a method for the biological treatment of a raw effluent to be implemented, capable of controlling the metabolism of the biomass, principally comprising the following steps:

a) an effluent to be treated entering by route 11 is brought into contact with, principally, free cultures forming part of the biological sludges, in at least one tank or biological treatment reactor 12;

b) a fraction of the sludges of the biological treatment reactor is sent, at a defined rate, to one (or even several) bioactivation reactor(s) 15 which is (or are) isolated vis-à-vis the reactor 12 and which can be individually aerated, or micro-aerated (i.e. aerated with a bubbling of micrometric size), or anaerobic, so as to perform biological adaptations of the state of the biomasses of this fraction under the influence of various factors (alone or combined) such as a nutritional deficiency, a moderate inhibition (i.e. a moderate nutritional deficiency), the pressure, the temperature, the pH, the change in electron acceptor (this list not being limiting),

c) for each bioactivation reactor, a recirculation loop 17 ensures the coupling to the biological treatment reactor 12, and allows between 30 and 300% of the bioactivated sludges to be sent back to the biological treatment reactor 12.

It is specified that the recirculation rate is defined with respect to the reference production of sludge, measured at the activated sludge reactor blow off level.

The residence time of the sludges in the bioactivation reactor 15 is controlled by the measurement of parameters representing the biological state of the sludge which is isolated there (suspended matter, nitrogenous forms, soluble and total COD, enzymatic activity, proteins, polysaccharides, composition of the biomass, etc.) and is specific to each type of sludge.

The recirculation rate, specific to the treatment in each bioactivation reactor, is a function of the biological state of the biological sludge and the bioactivated sludge.

A tank, situated after the bioactivation zone 15 but before the return to the biological sludge tank 12, can be added (see FIG. 12), in order to allow the state of the biomass (suitable biological species, specific enzymes, production of products of interest) to be preserved in a state such that their return to the biological treatment reactor allows a more thorough degradation of the organic matter and/or the compounds of interest produced to be conditioned in order to be able to valorize them to another reactor system.

A prior stage of thickening the excess sludges is advantageously carried out in zone 14 by any means allowing the thickening of the sludge (at a maximum of 40 kg/m³ for mesophilic populations). The thickening can be done, for example, using a membranous technique, a draining table, a static thickener, a rotary drum, etc.

The thickening, which is optional, serves on the one hand, in the case of non-thickened sludges, to increase the substrate-biomass contact surface and on the other hand to reduce the volume of the tank. A mixer can ensure a homogeneity in the case of thickened sludges, but oxygen transfer is no longer effective above a certain threshold (40 kg/m³).

The bioactivation reactor can also function with various families of bacteria such as psychrophiles or thermophiles, for example, by adapting the operating conditions of the reactor.

Generally, the invention can be implemented with any method for the biological treatment of polluted effluents and waste. In particular, the biological treatment can be carried out using conventional methods eliminating carbon, ammonium or nitrates, for example activated sludges, MBRs (membrane bioreactors), or MBBRs (moving bed bioreactors).

An implementation was carried out by way of example over 21 days. The activated sludges (in the case of the example) are concentrated between 4 and 40 g/L by settling (this choice is not imperative) and placed in a continuously aerated column (acting as bioactivation zone) in order to promote bacterial growth without introducing nutrients.

The reduced introduction of nutrients to the bioactivation reactor, because of its isolation, brings the bacteria into a state of nutritional deficiency that creates a state of adaptation of the biomass.

Monitoring the biological parameters and the concentration of sludge was carried out. The monitoring, in the bioactivation reactor, is performed on the basis of measurements of the soluble COD and nitrates, to which other parameters can be added, such as the NH₄⁺ ion, proteins, exopolysaccharides or cellular activity which allow a continuous and in-situ analysis and therefore a fine control (or command).

From a time comprised between 1 and 21 days, a specific biological state of the biomass that is very nearly constant, i.e. a plateau, is observed.

When in operation, the bioactivation reactor 15 is controlled in order to function permanently under conditions equivalent to the point of reaching the plateau so that the degradation of the polluting matter takes place after the recirculation into the biological tank for treating the effluents.

In other words, within the isolated fraction of sludges in the bioactivation reactor the appearance of bacteria is favoured which are capable of degrading at least one of the types of pollution present as not spontaneously degraded in the biological treatment reactor.

Moreover, it is advantageous not to allow this new bacterial species to develop within the bioactivation reactor, but to send it to feed in the biological treatment reactor.

The thickened and activated sludges are recirculated into the upstream biological treatment reactor in order to increase the enzymatic activity within the biological reactor of the effluents and to allow the solubilization of the pollution that is difficult to biodegrade thus reducing the production of sludges of the system and/or thus increasing the production of compounds of interest.

The recirculated volume is chosen according to the state of the biomass. The residence time in the bioactivation zone is predetermined depending on the type of sludge.

As indicated above, an additional conditioning stage can be added with a view to conditioning the compounds of interest before recirculation and/or valorization to another reactor system. Compounds of interest can be activated carbon, enzymes (for example proteases, carbohydrases, lipases or oxidases), bioplastics, biopesticides and biogases, among others.

### Example 1

### Mono-Bioactivation Method

With reference to FIG. 2, an embodiment example of the method according to the invention involving a single bioactivation (mono-bioactivation method) is shown.

The treated water is waste water from an urban environment containing 150 mg/L of MES, a total COD of 500 mg/L, a soluble COD of 250 mg/L, a nitrogen concentration (ammonia equivalent) of 35 mg/L, a TN (total nitrogen) level of 50 mg/L, and a phosphorus concentration (phosphate equivalent) of 6 mg/L.

Screened waste water 61 is introduced in sequence or continuously into an activated sludge tank 62. For example, it is introduced with a continuous flow of 130 L/h. The activated sludge tank has a volume of 1100 L.

When the tank 62 is not being fed by a pump, the water returns in a closed loop to a storage tank. A stirrer allows the inlet effluents to be homogenized with the activated sludge present but need not break up the flocs. A fine bubble aeration aerates the mixture in order to allow bacterial growth as well as the processes of decarbonation and nitrification/denitrification.

The sludge between 3 and 5 g/L is discharged to a bioactivation reactor 64, with a volume comprised between 80 and 350 L. The transfer of this sludge from the activated sludge tank to the bioactivation reactor is noted by reference 63. The flow transferred to the bioactivation reactor is from 44 to 264 L/d. Excess sludges 66 also leave the activated sludge tank. The rate of treatment of the sludges is from 30 to 600%.

Flat membranes play the role of clarifier, i.e. separator of the sludges from the clean water. The extracted permeate is analysed to find out its nitrates content in order to regulate the sequenced nitrification/denitritication. An aeration system allows clogging of the membranes to be avoided.

A volume of activated sludges is introduced in a sequenced fashion within the bioactivation reactor. The sludge is thickened up to 20-25 g/L by two submerged membrane modules.

The extracted permeate 67 is analysed to find out its nitrates content in order to regulate the sequenced nitrification/denitritication. The outlet flow is 110 L/h and is in sequenced mode (8 minutes out of 10), which avoids clogging the membranes. A large bubble aeration at the level of the membranes allows their clogging to be avoided and a fine bubble aeration at the bottom of the tank allows bacterial growth.

The imposed conditions (biological residence time) depend on the nature of the sludge of the activated sludge tank and allow the enzymatic activity to increase. In the described example, this method is implemented such that the biological residence time (i.e. the residence time in the bioactivation tank 64) is preferably 7 days.

A 20-25 g/L sludge volume (reference 65) is recirculated daily to the activated sludge tank by a positive displacement pump, so as to degrade the particulate COD and therefore to reduce the production of sludges.

In FIG. 3, the total COD (Dt), the soluble COD (Ds) and the polysaccharides (P) of the sludge placed in aerobic stabilization are monitored as a function of time.

This makes it possible to find out the duration of the plateau (zone where the COD no longer changes, and where there is a selection and a “bioactivation of the flora”); and therefore the time needed for the adaptation of the bacteria to the medium: 3 to 9 days in the above example, where the soluble COD passes from 50 mg/L to approximately 450 mg/L and the polysaccharides from 5 to approximately 150 mg/L.

If the COD increases, there is solubilization. Thus, the matter is converted and free in the sludge of the soluble pollution which is therefore easier to assimilate. When the plateau of total COD is reached, the bioactivation is at its maximum. The enzymes or species put in place allow the matter to be converted.

Similarly, in FIG. 4, the total nitrogen (Nt), the soluble nitrogen (Ns) as well as the nitrates (Ni) were monitored as a function of time.

The same plateau that starts from the 3^{rd} day is found: increase in the nitrates from 2 to 100 mg/L and therefore parallel to the soluble nitrogen but not to the total nitrogen which remains stable at approximately 600 mg/L.

The measurements thus allow a change in the nitrogenous forms at the same time as the solubilization of the COD.

The method involves a stabilized biological operation taking into consideration a repetition of the cycle of removing a fraction of the sludges, its isolation, then its reinjection according to a given recirculation rate.

FIG. 5 represents the monitoring of the content of sludges in the activated sludge tank (the scale of the y-axis being logarithmic). The MES (suspended matter) concentration of the activated sludge is stable at about 5 g/L. The same is true of the MS (dry matter) and MVS (volatile suspended matter) concentrations. In this figure, two reference periods occur, i.e. periods during which the activated sludge tank functions in a stable pattern.

FIG. 6 represents the change in the content of sludges in the bioactivation reactor (there is a single reference period because the bioactivation was started once the activated sludge had been stabilized).

The content (representing the various matter contained in these sludges) is stable. The MES concentration is 18 g/L, the MS concentration is 20 g/L and the MVS concentration is 15 g/L. They are obtained with a thickening process, and are very satisfactory. The sludge volume is reduced, and the aeration is nevertheless satisfactory.

Recirculation is then established.

FIGS. 7 and 8 respectively represent the change in the sludge in the activated sludge tank (AS, FIG. 7) and in the bioactivation zone (BI, FIG. 8) in different recirculation phases.

Over the first weeks, at a reduced recirculation rate (30% by mass, zone R), the results show a stability in the concentrations of the two tanks: the activated sludge in the main tank is at approximately 6 g/L and the bioactivated sludge in the bioactivation tank at 20 g/L.

During the increase in the recirculation rate to 100% (zone E for a high recirculation rate), a significant drop in the content of sludges in the two tanks can be noted, after only two weeks.

Thus, a reduction in the content of matter in the tanks (4.5 g/L and 16 g/L respectively) is obtained, hence a reduction in the production of sludges at the outlet of the plant.

### Example 2

### Implementation of the Method with Tanks in Series

FIG. 9 diagrammatically represents a plant 210 similar to that of FIG. 1, but comprising several bioactivation reactors in series, each of them imposing different conditions in order to promote different enzymatic reactions and therefore enrich the biodiversity. Moreover, the product or products of the reactions of an upstream reactor are then used as substrates for the reactions of a downstream reactor. In the example described, the carbon is converted into volatile fatty acids, and these are converted to methane or PHA biopolymers.

The elements similar to those of FIG. 1 are indicated by a number derived from that of FIG. 1 by adding the number 200, the reactors being referenced 215A, 215B and 215C.

It can be noted that there is a reinjection (or recirculation) line 217 for each bioactivation reactor. It is a concentrated outlet (at the bottom, containing bioactivated sludges). For each reactor, there is also a clear outlet (at the top), the flow of which can be partially recirculated to the reactor 212 (route 222) if it is desired to control the residence time of certain soluble fractions in a different way to the residence time of the activated sludges. Finally, an outlet route to outside the plant is also provided for each reactor (towards the bottom).

In a variant, not represented, the outlet flow of the reactors 215A and 215B is divided between the following reactor (215B and 215C respectively) and a common reinjection line 217; which can allow the proportions transmitted to the following reactor and reinjection to be varied.

Different parameters are also monitored depending on the matter to be degraded or produced. An assembly of tanks in series allows chain reactions to be carried out, each tank carrying out a link in the chain of reaction.

The final yield is higher. In the example described, 0.6 g of VFA per gram of COD, then 0.65 g of methane per gram of carbon are obtained. In another example, 0.6 g of volatile fatty acid per gram of COD, then 0.11 g of PHA biopolymers per gram of COD are obtained. Without treatment in series, the yield would be divided by a factor of two, approximately.

### Example 3

### Implementation of the Method with Tanks in Parallel

FIG. 10 represents a plant 110 similar to that of FIG. 1 except that, instead of a single bioactivation reactor, there are several (115A, 115B, 115C), mounted in parallel, each of them being able to impose different conditions in order to promote several different enzymatic reactions and therefore enrich the biodiversity, so as to allow several different products to be obtained, each being able to be valorized. For example, in the case of the conversion of carbonaceous matter, the volatile fatty acids produced can be extracted, without being converted to PHA biopolymers.

In this FIG. 10, the elements similar to those of FIG. 1 are denoted by the reference numbers derived from those of this FIG. 1 by adding the number 100; the various bioactivation reactors are referenced 115A, 115B and 115C.

In the example schematized here, the recirculation of all or some of the content of these bioactivation reactors could be ensured by the same line, but there is one reinjection line for each reactor 115A to 115C, the lines being numbered 118A, 118B, 118C. An outlet route to outside the plant is provided for each reactor, on the right of the diagram.

By way of example, the reactor 115A is conditioned so as to bring about the occurrence of a biological species capable of consuming the substrates that are difficult to degrade A, the reactor 115B is conditioned so as to bring about the appearance of another biological species capable of consuming the substrates that are difficult to degrade B and the reactor 115C is conditioned so as to bring about the development of a biological species capable of consuming the substrates that are difficult to degrade C.

This assembly makes it possible to proceed with degradations under different bioactivation conditions in the different tanks.

Different parameters are monitored depending on the matter to be degraded or produced. For example, proteins or fibres can be monitored if it is desired to degrade such substrates. The reduction of dissolved oxygen, or the occurrence of volatile fatty acids, or other parameters, can also be monitored.

In the example, described in the first reactor 115A, volatile fatty acids are produced in order to then be extracted from the method.

In the second reactor 115B, PHA biopolymers are produced and also extracted from the method.

In the third reactor, the environmental conditions are adjusted to promote enzymatic activity (for example proteases) and to degrade the matter. In this reactor, the degradation of the pollution is promoted.

The following numerical values are obtained: volatile fatty acids yield 0.6 g per gram of COD; biopolymers yield 0.11 g per gram of COD; proteases yield 0.01 g per gram of carbon. At equilibrium, i.e. in the exploitation phase, the production obtained is 230 g per day of PHA biopolymers and 1250 g per day of volatile fatty acids. 2060 g of proteases are recirculated per day out in order to promote the degradation of the matter in the activated sludge tank.

FIG. 11 presents the yields of PHA biopolymers, volatile fatty acids and proteases obtained with and without using the method, the values on the y-axis being in grams per day. The effect of the method is clearly visible.

### Example 4

### Implementation of the Method with Conditioning

FIG. 12 represents a plant 310 similar to that of FIG. 1 except that an additional conditioning stage, reference number 330, that is not obligatory, is added on the reinjection line between the outlet of the bioactivation reactor 315 and the inlet of the biological treatment reactor 312.

The object of this conditioning stage is the conditioning of the compounds of interest before recirculation and/or valorization, with the aim of increasing the efficiency of the production of compounds of interest (enzymes, biopolymers, etc.).

In FIG. 12, elements similar to those of FIG. 1 are given reference numbers derived from those of FIG. 1 by adding the number 300.

### Example 5

### Another Implementation of the Method with Conditioning

FIG. 13 represents a similar plant 410 which, in this particular case, involves a micro-aerated or non-aerated bioactivation reactor 415 producing volatile fatty acids by acidogenesis, according to a fermentation process.

This reactor 415 is installed in communication with an aerated biological treatment reactor 412. The waste water inlet is numbered 411, and a route for supplying the bioactivation reactor by the biological treatment reactor is referenced 414, and involves a thickening process, or does not. The excess sludges leave the biological treatment reactor by the route 420, and the treated water by the route 421.

In the context of this particular example, a separation method, reference number 408, is also implemented, followed by a method of precipitation of nitrogen and/or phosphorus. These two stages are optional.

A bioactivation reactor for aerated conditioning, having reference number 409 and comprising two tanks, is also implemented. At the outlet of the first tank of this reactor, a production of microorganisms 430 capable of accumulating biopolymers, by bioaugmentation, i.e. bio-organism enrichment is obtained. At the outlet of the second tank, a production of biopolymers 440 is obtained.

1-18. (canceled)

19. A method for the biological treatment of an effluent containing two or more types of organic pollution wherein a first type of organic pollution is easier to degrade than a second type of organic pollution, comprising:
degrading the easier to degrade first type of pollution by bringing the effluent into contact with biological sludge capable of consuming the easier to degrade first type of pollution in a main aerated biological treatment zone;
removing at least a fraction of the biological sludge from the main biological treatment zone and isolating the removed sludge at a distance from the main biological treatment zone in a bioactivation zone, wherein the sludge in said bioactivation zone is treated by subjecting the sludge to aeration and residency time conditions that gives rise to the development of new biological functions in the removed sludge such that the removed sludge is capable of biologically degrading the more difficult to degrade second type of pollution;
recycling at least a fraction of the removed biological sludge comprising the new biological functions to the main biological treatment zone; and
degrading the more difficult to degrade second type of pollution utilizing at least a portion of the sludge treated in the bioactivation zone.

20. The method according to claim 19, wherein the bioactivation zone is aerated and the residence time of the removed sludge is between 1 and 21 days.

21. The method according to claim 19, wherein the bioactivation zone is anaerobic and the residence time of the removed sludge is a function of the age of the biological sludge.

22. The method according to claim 19, wherein the amount of biological sludge that is removed from the main biological treatment zone is between 30% and 600% of a daily production of sludge in the main biological treatment zone.

23. The method according to claim 19, wherein the aeration and time conditions in the bioactivation zone are defined as a function of the biological state of the removed sludge, wherein such biological state is monitored by measuring one or more parameters representative of one or more biological functions, and said aeration and residency time conditions are adjusted periodically so as to maintain or change said biological functions in said bioactivation zone.

24. The method according to claim 23, wherein the one or more parameters is selected from suspended matter (or MES), soluble or total chemical oxygen demand, nitrogenous species, enzymatic activity, protein content, polysaccharides content, or biomass composition.

25. The method according to claim 19, wherein the aeration and time conditions are chosen so as to maintain or change at least one phenomenon selected from a nutritional deficiency, a moderate inhibition, a pressure, a temperature, a pH, or the nature or concentration of electron acceptors.

26. The method according to claim 19, wherein the aeration and time conditions are such that at least one type of pollution is degraded by the removed sludge after removal of the sludge from the biological treatment zone and before recycling.

27. The method according to claim 19, wherein the aeration and time conditions are such that conditioning of a valorizable part of the removed sludge is performed after removal from the biological treatment zone and before recycling.

28. The method according to claim 19, wherein before the recycling of the removed sludge, at least one subfraction of the removed sludge is subjected to aeration and time conditions sufficient for bringing about the development of other new metabolic functions capable of consuming one or more further types of pollution, and at least a part of the subfraction is recycled to the biological treatment zone.

29. The method according to claim 19, wherein at least one additional fraction of biological sludge is removed and isolated from the biological treatment zone under aeration and residency time conditions sufficient for bringing about the development of other new metabolic functions capable of consuming one or more further types of pollution, and at least a part of this additional fraction is recycled to the biological treatment zone, the removed sludge and the additional fraction of sludge being treated in parallel bioactivation zones.

30. The method of claim 19, wherein the development of new biological functions includes a proliferation of a biological species, a modification of a distribution of a production of intracellular enzymes, a modification of a distribution of emission of exocellular enzymes or a modification of a population dynamics of a species.

31. The method according to claim 19, wherein a concentration treatment is applied to the removed sludge before bringing about the development of new biological functions in the removed sludge.

32. The method according to claim 31, wherein the removed sludge is concentrated to at most 40 kg of sludge per m³ of liquid when the majority of the biomass in the removed sludge is mesophilic bacterial populations.

33. The method of claim 19 including maintaining the oxygen concentration in the bioactivation zone at less than 2 mg/l.

34. The method of claim 19 wherein the aeration and time conditions imposed in the bioactivation zone gives rise to a biomass that degrades the more difficult to degrade second type of pollution.

35. A wastewater treatment system for treating an effluent containing two or more types of organic pollution including a first type of organic pollution that is relatively easy to degrade and a second type of organic pollution that is relatively difficult to degrade, the wastewater treatment system comprising:
a main aerated biological treatment zone for receiving the effluent to be treated and wherein the main aerated biological treatment zone is adapted to contain activated sludge where the activated sludge is effective to degrade the first type of organic pollution in the main aerated biological treatment zone;
a bioactivation zone isolated from the main aerated biological treatment zone;
conduit means for directing a fraction of the activated sludge from the main aerated biological treatment zone to the bioactivation zone;
the bioactivation zone adapted to condition the fraction of activated sludge by subjecting the fraction of activated sludge to varying aeration and residency time conditions to produce biological species in the bioactivation zone that are capable of degrading the second type of organic pollution in the effluent; and
means for recycling the conditioned fraction of activated sludge from the bioactivation zone to the main aerated biological treatment zone where the biological species produced in the bioactivation zone are effective to degrade the second type of organic pollution in the effluent.

36. The wastewater treatment system of claim 35 including a sludge thickening zone disposed between the main aerated biological treatment zone and the bioactivation zone for thickening the fraction of activated sludge prior to the fraction of activated sludge reaching the bioactivation zone.

37. The wastewater treatment system of claim 35 wherein there is provided a plurality of bioactivation zones disposed in series relationship.

38. The wastewater treatment system of claim 35 wherein the wastewater treatment system includes a plurality of bioactivation zones and where the bioactivation zones are disposed in parallel relationship and wherein there is means for recycling the conditioned activated sludge from each of the bioactivation zones to the main aerated biological treatment zone.
